(19) United States
(12) Patent Application Publication
(10) Pub. No.: US 2012/0174280 A1
(43) Pub. Date: Jul. 12, 2012

(54) Channel Release System and Garment Incorporating Same

(76) Inventors: David R. Strum, Amissville, VA (US); David M. Duncan, Ashburn, VA (US); Gregory E. Day, Great Falls, VA (US)

(21) Appl. No.: 12/496,982

(22) Filed: Jul. 2, 2009

Related U.S. Application Data
(60) Provisional application No. 61/153,077, filed on Feb. 17, 2009.
(60) Provisional application No. 61/174,738, filed on May 1, 2009.

(51) Int. Cl. A41D 13/00; B23P 19/04; A41D 1/00; F16B 1/00; A44B 11/25

(52) U.S. Cl. 2/69; 24/595.1; 29/428

(57) ABSTRACT

A channel release system provides a platform member and sub-components that stack in a staggered/separated order and align in a channel when used together. A pin member slides through the channel and locks them together. When the pin is pulled through the channels, any secured components or equipment are released and can fall away. The channel release system of the present invention enables users to quickly release clothing, materials and other items to improve mobility, facilitate care and provide other benefits.

### REFERENCE TO RELATED APPLICATIONS

This application claims the benefit of U.S. application Nos. 61/153,077, filed Feb. 17, 2009 and 61/174,738 filed May 1, 2009, both of which are entitled “Channel Release System and Ballistic Clothing Incorporating Same”, the disclosures of which are incorporated by reference herein in their entireties.

### FIELD OF THE INVENTION

The present invention relates to quick release systems, and more particularly to a versatile channel release system for a variety of applications, including ballistic carriers, garments or vests, for example, that contain soft or hard armor to protect combat personnel.

### BACKGROUND OF THE INVENTION

Military and law enforcement personnel engaged in hostile environments are vulnerable to rifle ammunition and fragmentation, shrapnel, improvised explosive devices, bullets, bombs, and other lethal and damaging projectiles (i.e., “penetrating elements”). Ballistic clothing, such as an armored vest, provides at least some protection from these penetrating elements. However, such clothing is not easily removed, can be burdensome, can restrict mobility and rapid removal when submerged in water or any other operational need, and can undermine efforts to minimize movement during triage in the event of a casualty. Efforts to provide quick-release clothing to date generally utilize loops through a ring with a wire and/or cord in the design. Such methods have limited effectiveness and are difficult to quickly re-install.

### SUMMARY OF THE INVENTION

The present invention provides a channel release system for various applications, including on ballistic clothing, wherein the channel release system enables users to quickly release clothing, materials and other items to improve mobility, facilitate care and provide other benefits. In one embodiment of the present invention, the channel release system can release two or more parts of an armor component or other equipment, thereby allowing the user to instantly jettison the armor or equipment.

### BRIEF DESCRIPTION OF THE DRAWINGS

FIG. 1 is a front left perspective photographic view of an armored vest for use with the present invention.

FIG. 2 is a rear left perspective photographic view of an armored vest for use with the present invention.

FIG. 3 shows a right front perspective view of a plate member and pin in accordance with one embodiment of the present invention.

FIG. 4 shows the rear view of the vest in FIG. 2 with the embodiment of the channel release system of FIG. 3 incorporated therein.

FIG. 5 is a photographic view of the channel release system in accordance with one embodiment of the present invention as secured to the back section of an armored vest.

### DETAILED DESCRIPTION OF EMBODIMENTS OF THE PRESENT INVENTION

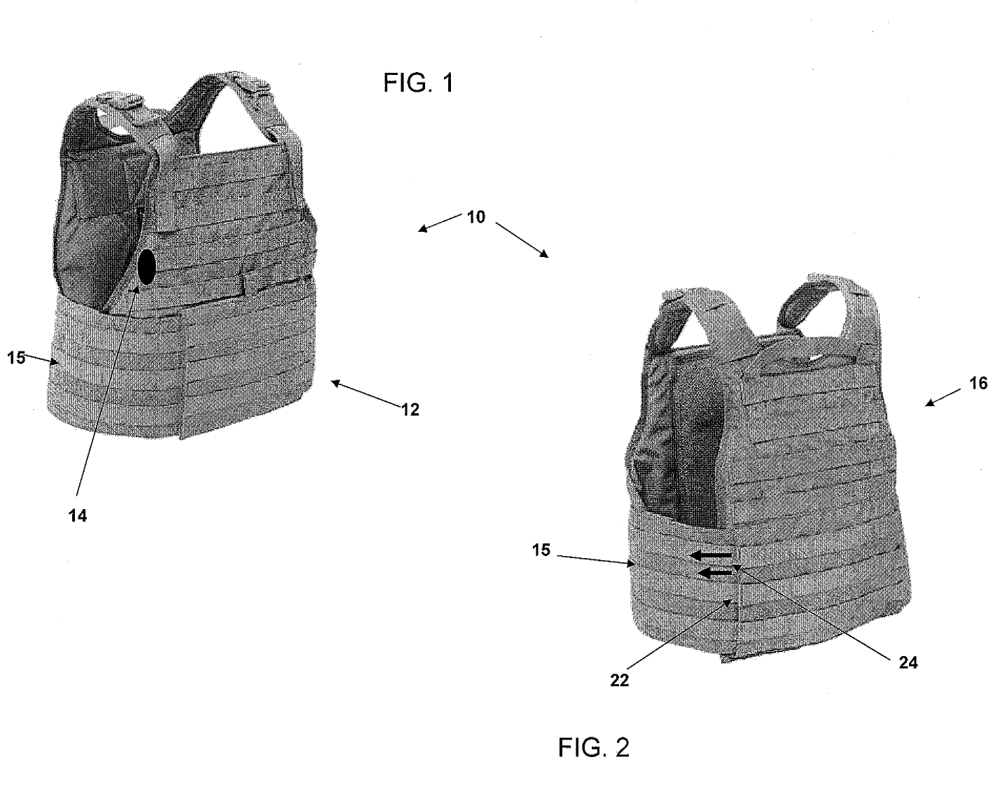

As shown in FIGS. 1 and 2, a garment 10 such as a ballistic vest is provided with front 12 and back 16 faces and a cummerbund portion 15. A handle or pull cord location 14 on the front face 12 establishes a quickly accessible location for the wearer or another individual to activate the channel release system of the present invention. In one embodiment of the present invention, the channel release system releases from the area between the cummerbund portion 15 and a shoulder portion of the garment, as indicated by arrow 22. The release mechanism allows the vest to separate as indicated by the thick double arrows 24.

In one embodiment, the channel release system of the present invention works by way of one or more channels and a “channel stop” or sliding pin. A platform member and any sub-components can provide one or more channels that release or facilitate the releasing and separating of armor components or equipment. The platform and sub-component channel(s) stack in a staggered/separated order and align when used together. A pin member slides through or otherwise engages the channels contained on both the platform and the sub-component(s) and locks them together.

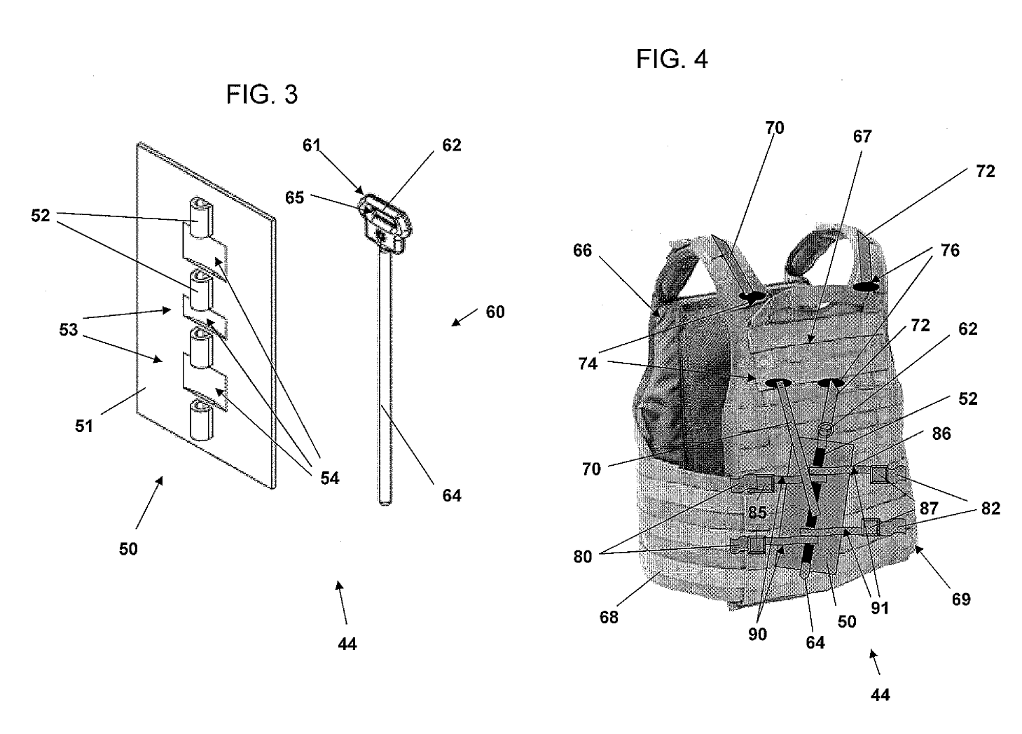

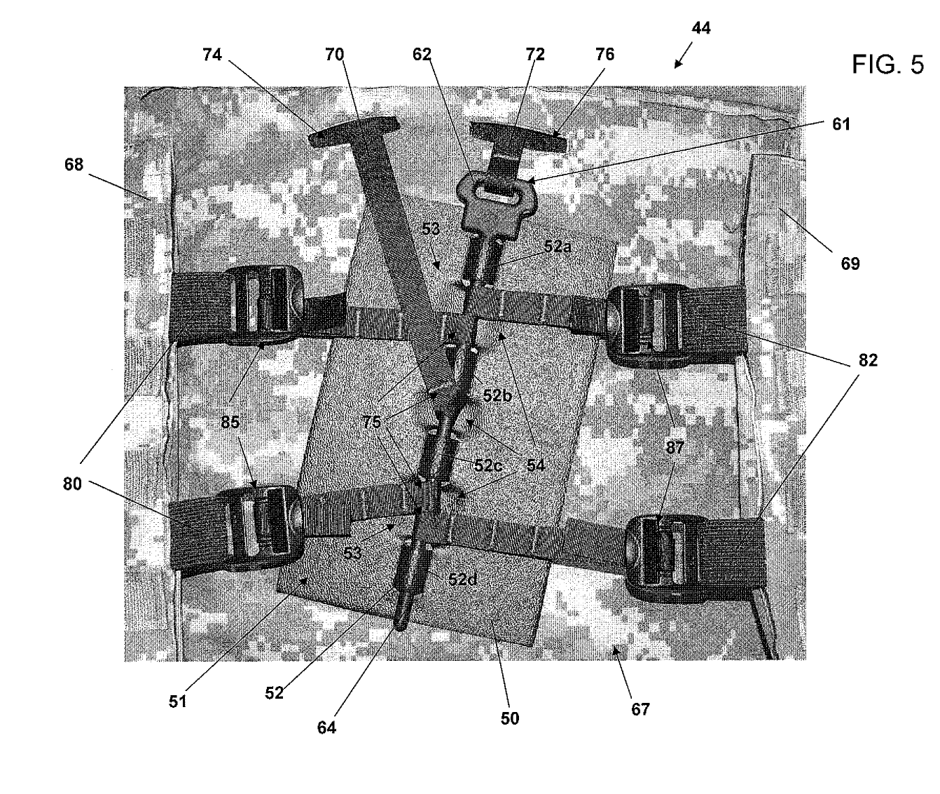

FIGS. 3 through 5 illustrate a first embodiment of the channel release system 44 of the present invention. As shown in FIG. 3, this embodiment of the channel release system 44 includes a plate or platform member 50 having a front face 51 with one or more channel guide members 52 secured thereon. In the embodiment with multiple channel guide members, the guide members are arranged in a vertical series on the plate member face 51. Each guide member 52 has a wall that is substantially horseshoe-shaped or U-shaped in cross-section, with the wall defining an opening between itself and the front face of the platform member. The guide members are arranged so as to provide a gap or gap portion 53 on the face in between each guide member and the next guide member in the series. Each opening defined by each guide member is part of a channel through which a pin member 60 can slide. In one embodiment of the present invention, the pin channel can comprise the guide member openings and the openings in loops of the webbing members described below and shown in FIGS. 4 and 5, for example. The front face 51 can optionally be provided or formed with one or more indentations 54 formed at the gap portion(s) of the face to assist in appropriately engaging the connection element 75 (e.g., loop members) extending from portions of the garment or other element. The pin member 60 of the channel release system has a head portion 62 and a shaft or body portion 64 secured thereto. The head portion 62 is formed so as to include an opening 65 therein for receiving a strap or webbing element as will be described below.

In one embodiment of the present invention, the pin 60 is comprised of a polyoxymethylene (“POM”) material (e.g., Delrin™ made by E.I. du Pont de Nemuors and Company, Wilmington, Del.) and the plate member 50 is comprised of Kydex® material, which is a type of thermoplastic acrylic-polyvinyl chloride alloy commercially available through Kydex LLC of Bloomsberg, Pa. The pin and plate members can be formed through injection molding and/or thermal forming techniques, for example. In one embodiment of the present invention, the plate member is approximately seven inches long by approximately four inches wide by approximately 0.10 inches in depth, with the guide members 52 positioned approximately in the vertical center of the plate front face 51. Each guide member 52 can be approximately 0.75 inches in length by approximately 0.45 to 0.5 inches in width, and further can be approximately 0.33 inches high. The indentations 54 can also be formed and positioned approximately in the vertical center of the plate front face 51, with indentations varying in size depending upon the number of straps or webbing elements to be held between respective pairs of guide members 52. In the embodiment of the present invention as shown in FIG. 3, for example, the indentations 54 have a width of approximately 1.27 inches, the distance between the top two guide members is approximately 1.14 inches, the distance between the middle two guide members is approximately 0.75 inches, and the distance between the lower two guide members is approximately 1.14 inches. These dimensions may be appropriate when the webbing members (described below) are approximately 0.5 inches in width. However, the size of the overall plate member 50, guide members 52, and indentations 54 may be increased or decreased to handle different sizes and/or different applications of the present invention.

In one embodiment of the present invention, the pin member shaft 64 is approximately 0.25 inches in diameter and approximately 6.78 inches in length, and the pin member head portion 62 is approximately 1.43 inches wide and approximately 1.06 inches tall, such that the total length of the pin member is approximately 7.83 inches. The pin member head portion 62 can also have an opening of approximately 0.25 inches high by approximately 0.75 inches wide to securely receive the loop portion of the webbing member 72 as described below.

As shown in FIGS. 4 and 5, the channel release system 44 is secured to a back portion 67 of the vest or garment assembly. Typically, this occurs by sewing the plate member 50 into the garment material itself. In one embodiment of the present invention, as shown in FIGS. 4 and 5, the plate member is sewn into the back of the garment at a slight angle from the vertical, in order to facilitate the tracking of a webbing element over one shoulder of the vest wearer, thereby facilitating the quick and easy release aspects of the present invention. In one embodiment, the plate member is sewn to the garment back portion using nylon thread.

As further shown in FIGS. 4 and 5, the channel release system 44 includes sub-components in the form of webbing elements 70, 72, 90 and 91, which can be made of fabric material, for example. Webbing elements 90, 91 are capable of being secured by sewing, for example, at a first end to a first 68 or second 69 cummerbund element, respectively, and are each provided with a second end capable of being formed into a connection element 75. The connection element 75 can be a hook and loop-type fastener that mates with another hook and loop-type material on the pin member, or can be a loop member, for example. In the embodiment where the connection element 75 is a loop member, the loop member can be formed by being sewn back onto the respective webbing element or by using hook and loop fasteners, for example, wherein each loop forms an opening of sufficient size to receive the pin shaft 64. In this way, the cummerbund elements 68, 69 can be held in place against the back 67 of the garment. In one embodiment of the present invention, as shown in FIGS. 4 and 5, the first end of each of the webbing elements 90 is secured to a respective buckle element 85, which extends from a respective strap member 80 that is secured to the first cummerbund element 68. Similarly, the first end of each of the webbing elements 91 is secured to a respective buckle element 86, which extends for a respective strap member 82 that is secured to the second cummerbund element.

Webbing element 70 is capable of being secured at a first end to the front of the garment, with a second end also formed into a connection element 75 such as described above. In the embodiment of the present invention where the connection element for webbing 70 is a loop member, the loop forms an opening of sufficient size to receive the pin shaft 64. Webbing element 72 is a pull cord webbing member capable of being secured at a first end to the front of the garment, with a second end also formed into a connection element, which can be another loop member formed, for example, by being sewn back onto itself or optionally having hook and loop fastening elements secured thereto, wherein the loop forms an opening of sufficient size to extend around the top portion 61 of the pin member 60 such that when the webbing element 72 is pulled, it directly pulls the pin member 60. Webbing elements 70, 72 may extend along the outside of the front and back portions of the garment, or as shown in FIGS. 4 and 5, may extend into slits 74 and 76 formed into the vest to guide the webbing elements internally through the front and/or back vest portions, and to sustain the integrity and balanced fit of the garment. The first end of webbing element 72 can have a cord, handle, grip or other handling element secured thereto, enabling a user (e.g., wearer of the vest or other person) to pull the handling element, to thereby pull the pin out of the channels on the plate member 50. In one embodiment of the present invention, only webbing elements 72, 90 and 91 are provided, and there is no fourth webbing element 70.

It will be appreciated that the webbing elements 70, 72, 90 and 91 of the embodiment of the invention in FIGS. 4 and 5 help to maintain the garment in secure and comfortably fitting arrangement around the wearer. The webbing elements can be adjusted for users of different size using the buckle members, for example.

In operation, the garment can be pre-assembled by the wearer of the garment before it is worn. Alternatively, the garment can be assembled on the wearer with the help of another person. The garment assembly includes the front 66 and back 67 members, as well as the side cummerbund members 68, 69. In one embodiment of the present invention, these members are independent and unconnected prior to assembly. The cummerbund members 68, 69 can be secured to the front garment portion 66 by hook-and-loop (e.g., Velcro™) or similar type fastener. The front portion 66 can be secured to the back portion by webbing elements 70 and 72, which can extend externally or internally (or a combination of both) from the front garment portion to the back garment portion. The second ends of the webbing elements 70 and 72 are shown exiting the back portion 67 of the vest through slits 74 and 76, respectively. The front and back portions will not remain secured until the pin attached at the end of the webbing element 72 is inserted within the channel release system of the present invention as described below.

The cummerbund members 68, 69 can be secured to the back garment portion 67 by the webbing elements 90 and 91, as the loops at the second ends of the webbing elements can receive the pin shaft 64 as it extends through the channel guides 52 on the plate member 50 of the channel release system 44. As can be seen in the embodiment of the present invention shown in FIG. 5, the pin shaft 64 first passes through a first channel guide 52a, then through a loop in the webbing element 91 connected to cummerbund element 69, then through a loop in the webbing element 90 connected to cummerbund element 68, then through a second channel guide member 52b, then through a loop in the webbing element 70 connected to front vest element, then through a third channel guide member 52c, then through a loop in the webbing element 91 connected to cummerbund element 68, then through a loop in the webbing element 90 connected to cummerbund element 69, then through a fourth channel guide member 52d. As can be seen, the loops of the webbing elements can lie in different gap areas 53 or the same gap area on the plate front face 51. In such an arrangement as described, the balance of forces exerting pulling pressure against the various vest elements can be managed for the wearer's comfort and overall fit of the garment. Further, the insertion of the pin through the various loops and channel guides acts to secure the front and back portions of the garment together, as well as the cummerbund elements and the back portion of the garment together, all at once. The tight fitting engagement and tolerances of the pin within the channel guides ensures that the pin does not release during normal wear. Rather, the pin is only released upon sufficient pulling pressure being applied by the wearer or another operator on the first end of webbing element 72 extending from the front portion of the garment.

The indentations 54 in plate member assist in making room for the connection elements 75 (e.g., loop members) of the various webbing elements when engaged with the pin shaft 64, thereby allowing for smoother travel of the pin through the guide members and loops. Also, by providing indentations, the overall height profile of the channel release system above the surface of the garment can be minimized. Nevertheless, the present invention does not require indentations 54 in order to work.

Further with regard to the operation of the garment, once a user pulls the handling element on the front of the garment at the end of the webbing element 72, the pin begins to move through the channel guide members and the loops. In the embodiment of the present invention where the connection elements 75 are hook and loop-type connectors, the pulling of the handling element results in a disconnection from elements 75. Once the pin is pulled through the first loops (one associated with the lower one of the webbing elements 90 and the other with the lower one of the webbing elements 91) or otherwise detached from the first connection elements, the lower webbing elements fall away, partially releasing the cummerbund elements from the back of the garment. As the pin is pulled further through the middle loop associated with webbing element 70 or otherwise detached from middle connection element 75, the front portion of the garment can begin to fall away from the back portion of the garment. Finally, as the pin travels through the last two loops (one associated with the upper one of the webbing elements 90 and the other with the upper one of the webbing elements 91) or the remaining connection elements depending upon the implementation, the upper webbing elements fall away, fully releasing the front 66 and cummerbund 68, 69 elements from the back portion 67 of the garment.

Among other advantages, the channel release system of the present invention is superior in design due to the fact it is easily repaired and set up again after separation. It is extremely lightweight, so it will not impact the carry load of the soldier or other user. The system, in one embodiment, can employ High Strength Polyethylene (HSPE), which does not wear out as quickly as cotton, nylon loops or cording.

It will be appreciated that the channel release system of the present invention can be employed in a wide variety of applications. For example, the present invention can be employed with medical personnel who need a quick method for releasing equipment, supplies, medicine and other items that might be contained in a portable and wearable container. Such a container may be secured to a thigh or other body portion of the wearer, and can still employ the same plate member and pin member of the present invention, with straps and/or webbing members having loops therein such that the pin can retain them securely as described. When the pin is pulled, the medical supply container can be quickly released and deployed, such as in the field, for example. The present invention can further be employed, for example, for other military purposes, such as to releasably secure a weapons or munitions pouch. Such a pouch could be used by a grenadier or other personnel on a shoulder or other body part. The present invention can further be employed in non-military applications, such as for a life preserver or personal flotation device. The present invention can further be employed on devices and articles not necessarily secured to a person, such as to release baggage or other items from a vehicle or aircraft, or to release compacted items such as tents or flooring, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A quick-releasing garment, comprising:
a front garment portion having a webbing member with a loop member at the end thereof;
a pair of cummerbund side portions, each having at least one webbing member secured thereto, with each webbing member having a loop member formed at the end thereof;
a back garment portion; and
a channel release system secured to the back garment portion, the channel release system including a plate member having a front face and one or more guide members secured thereto, with the one or more guide members having a wall forming an opening between the wall and the plate member front face, with the channel release system further including a pin member capable of extending through the guide member opening and the loop member of each webbing member of the cummerbund side portions and the front garment portion to securely and releasably engage the front garment portion and cummerbund side portions to the back garment portion.

2. The garment of claim 1, wherein the pin member has a head portion, and further wherein the garment includes a pull cord webbing member provided with a first end extending from the front garment portion and a second end secured to the pin member head portion.

3. The garment of claim 1, wherein the plate member front face includes a plurality of guide members secured and aligned vertically thereon, and wherein the front face includes an indentation in between at least two of the plurality of guide members.

4. The garment of claim 3, wherein the plurality of guide members are secured on the plate member front face in a series and so as to provide a gap between each guide member and the next guide member in the series, and wherein the front face further includes an indentation in the front face for each gap therein.

5. The garment of claim 4 wherein the loop of the front garment portion webbing member lies in a first gap and the loop members of the webbing member secured to each of the pair of cummerbund members lies in a gap different from the first gap.

6. The garment of claim 1 wherein the one or more guide members and the loop members form a pin channel.

7. A channel system for enabling quick release of articles secured thereby, comprising:
a plate member having a front face;
one or more guide members secured to the front face of the plate member, with the one or more guide members having a wall forming an opening between the wall and the plate member front face;
an external article having a loop member extending therefrom; and
a pin member extending through the guide member opening and the loop member of the external article to securely and releasably engage the article.

8. The channel system of claim 7 wherein the article is a ballistic vest.

9. The channel system of claim 7 wherein the loop member of the external article extends from a webbing member secured to the external article.

10. The channel system of claim 7 wherein the external article is a garment that has a plurality of loop members extending therefrom, and wherein the pin member extends through the plurality of loop members.

11. A quick-releasing garment, comprising:
a front garment portion having a webbing member with a loop member at the end thereof;
a pair of cummerbund side portions, each having at least one webbing member secured thereto, with each webbing member having a loop member formed at the end thereof;
a back garment portion; and
a pin member for releasably securing the front garment portion and the cummerbund side portions to the back garment portion, with the pin member extending through the loop member of the front garment portion and the loop member of each webbing member secured to the cummerbund side portions.

12. The garment of claim 11 wherein the pin member has a head portion that receives the loop member of the front garment portion.

13. A method for manufacturing a quick-release channel system, comprising:
forming a plate member with a front face and one or more guide members secured thereto, with the one or more guide members having a wall forming an opening between the wall and the plate member front face;
providing a front garment portion, a back garment portion and a pair of side cummerbund portions, with the front garment portion and the side cummerbund portions each including a webbing member having a loop member formed at the end thereat and
forming a pin member capable of extending through the guide member opening and the loop member of each webbing member of the cummerbund side portions and the front garment portion.

14. The method of claim 13 wherein the step of forming a plate member includes forming a plurality of guide members secured and aligned vertically on the front face of the plate member, and further includes forming at least one indentation in between at least two of the plurality of guide members.

15. The method of claim 14 wherein the plurality of guide members are secured on the plate member front face in a series and so as to provide a group of gaps, including a gap between each guide member and the next guide member in the series, and wherein the front face further includes an indentation in the front face for each gap therein.

16. The method of claim 15 wherein the loop member of the front garment portion webbing member lies in a first gap of the group of gaps and wherein the loop member of each webbing member secured to the cummerbund members lies in a gap of the group of gaps that is different from the first gap.

17. A quick-releasing garment, comprising:
a front garment portion having a webbing member with a front garment portion connection element the end thereof;
a pair of cummerbund side portions, each having at least one webbing member secured thereto, with each webbing member having a respective cummerbund connection element formed at the end thereof;
a back garment portion; and
a pin member for releasably securing the front garment portion and the cummerbund side portions to the back garment portion, with the pin member connecting to the front garment portion connection element of the front garment portion and at least one cummerbund connection element of at least on of the webbing members secured to the cummerbund side portions.
